(19) United States
(12) Patent Application Publication
(10) Pub. No.: US 2026/0149110 A1
(43) Pub. Date: May 28, 2026

(54) BATTERY CELL MODULE OF POUCH CELL BATTERY

(71) Applicant: GUS TECHNOLOGY CO., LTD., Taoyuan City (TW)

(72) Inventors: CHUNG CHIEH CHANG, Taoyuan City (TW); HENG CHEN KUO, Taoyuan City (TW); MING HUEI TSAI, Taoyuan City (TW); CHIH HSING LEE, Taoyuan City (TW); CHING CHI CHENG, Taoyuan City (TW)

(21) Appl. No.: 18/961,509

(22) Filed: Nov. 27, 2024

(51) Int. Cl. H01M 50/293; H01M 10/6551; H01M 10/6555; H01M 10/658; H01M 50/211

(52) U.S. Cl. CPC H01M 50/293; H01M 10/6551; H01M 10/6555; H01M 10/658; H01M 50/211

(57) ABSTRACT

The present invention provides a battery cell module of a pouch cell battery, which comprises multiple battery cells, multiple first bonding elements, and multiple second bonding elements. Each battery cell is used for storing electrical energy. Each first bonding element is a thin film, and each second bonding element is an elastic sheet. The thickness of the second bonding elements is greater than the thickness of the first bonding elements. The battery cells, the first bonding elements, and the second bonding elements are arranged parallel along a first direction. Each first bonding element adheres to the two adjacent battery cells, and each second bonding element also adheres to the two adjacent battery cells. Between the two adjacent battery cells, there is only one first bonding element or one second bonding element.

### FIELD OF INVENTION

The present invention relates to a pouch cell battery and more particularly to a battery cell module designed for use in the pouch cell battery.

### BACKGROUND OF THE PRESENT INVENTION

A pouch cell battery is a type of ion battery capable of storing and releasing significant amounts of electrical energy. Such batteries are widely used in automotive applications and energy storage systems. The ion battery types referred to herein include, but are not limited to, lithium-ion batteries.

A conventional pouch cell battery comprises a battery cell module, two bus structures, a protective case, and two electrodes. The battery cell module consists primarily of multiple battery cells arranged in parallel, each of which is used to store electrical energy. Each battery cell is equipped with two tabs which act as a positive or a negative pole. The bus structures are positioned at either end of the battery cell module, with each structure containing one or more busbars, and each tab is electrically connected to one adjacent busbar, allowing the battery cells to be interconnected in series or parallel via the tabs and the busbars. The protective case, typically made of metal, houses and secures the battery cell module while providing physical protection. Each electrode is electrically connected to one busbar and interfaces with external power transmission lines or electrical equipment. This configuration enables the battery cell module to supply power to external systems and facilitates the charging of the battery cells via the power transmission lines.

The battery cells are arranged sequentially, with multiple double-sided adhesive film bonding elements interposed between each pair of the adjacent cells. Each double-sided adhesive film adheres to the adjacent battery cells, thereby securing them in position to form the battery cell module. The protective case comprises a bottom plate, two opposing side plates, and a cover plate. The side plates are positioned laterally, with the battery cell module arranged between them. The battery cells are aligned sequentially in the direction oriented toward the side plates. The side plates clamp the battery cell module, and thermal adhesive is applied around the module. This thermal adhesive facilitates the transfer of heat generated by the battery cells during charging or discharging to the protective case, enabling the heat to be dissipated through the case.

The double-sided adhesive film is a thin material, and the distance between the two adjacent battery cells directly bonded by the film is minimal. As a result, heat generated by one battery cell is easily transferred through the double-sided adhesive film to the adjacent cell, causing the adjacent battery cell to heat up, adversely affecting its charge and discharge performance and reducing the overall heat dissipation efficiency of the battery cell module.

### SUMMARY OF THE PRESENT INVENTION

The main purpose of the present invention is to provide a battery cell module of a pouch cell battery. To achieve this purpose, the present invention employs the following technical solution:

A battery cell module of a pouch cell battery, comprising:
multiple battery cells, each battery cell used to store electrical energy and having a length and a thickness, each battery cell equipped with two tabs, and each tab acting as a positive or a negative pole of the battery cell;
multiple first bonding elements, each first bonding element being a thin film; and
multiple second bonding elements, each second bonding element being a sheet with a thickness and an elasticity in the thickness direction, allowing each second bonding element to elastically compress or expand in the thickness direction, the thickness of each second bonding element being greater than the thickness of each first bonding element;
wherein the thickness direction of the battery cells, the first bonding elements, and the second bonding elements is defined as a first direction, the battery cells, the first bonding elements, and the second bonding elements are arranged parallel along the first direction, the length direction of the battery cells is defined as a second direction, which is perpendicular to the first direction, and each battery cell has one tab configured at each end in the second direction;
each first bonding element is interposed between two battery cells and adheres to the adjacent two battery cells, each second bonding element is also interposed between two battery cells and adheres to the adjacent two battery cells, and between the two adjacent battery cells along the first direction, there is only one first bonding element or one second bonding element.

Each second bonding element can increase the distance between the two adjacent adhered battery cells, reducing heat transfer between the adjacent battery cells along the first direction and enhancing overall heat dissipation efficiency.

### BRIEF DESCRIPTION OF THE DRAWINGS

FIG. 1 is a perspective view of a pouch cell battery according to a preferred embodiment of the present invention;

FIG. 2 is an exploded perspective view of the pouch cell battery according to the preferred embodiment of the present invention;

FIG. 3 is an exploded perspective view of the preferred embodiment of the present invention;

FIG. 4 is a top view of the preferred embodiment showing the arrangement of the bus structure; and

FIG. 5 is an enlarged partial view of FIG. 4 showing the area marked “5”.

### DETAILED DESCRIPTION OF THE PREFERRED EMBODIMENTS

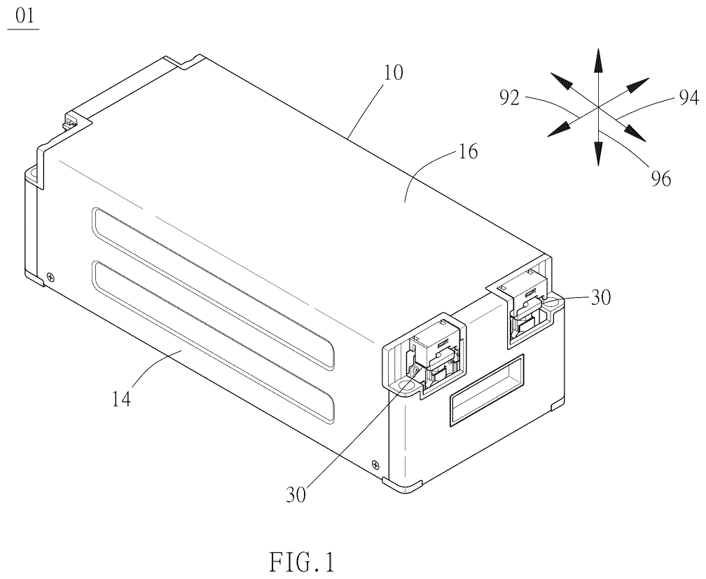

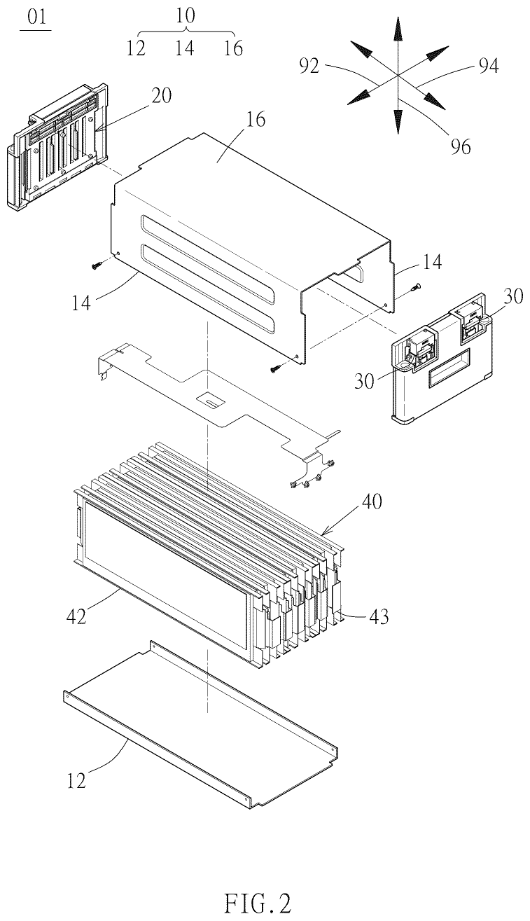

As shown in FIGS. 1 and 2, a pouch cell battery 01 comprises a protective case 10, two bus structures 20, two electrodes 30, and a battery cell module 40 shown by a preferred embodiment. The protective case 10 is mainly made of metal material and comprises a bottom plate 12, two opposing side plates 14, and a cover plate 16. The bottom plate 12 is used to support the battery cell module 40. The side plates 14 face each other laterally. The cover plate 16 is connected to the side plates 14, and each side plate 14 is connected to the bottom plate 12. The battery cell module 40 is positioned between the side plates 14 and between the bottom plate 12 and cover plate 16. The protective case 10 provides protection for the battery cell module 40.

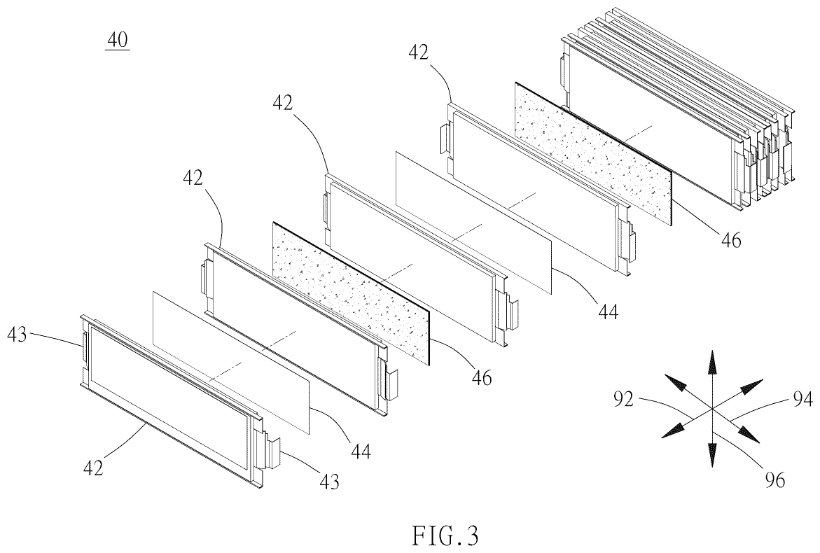

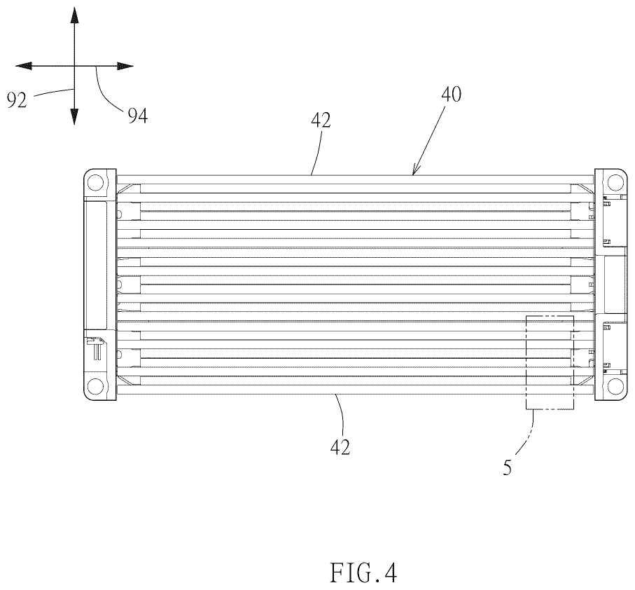

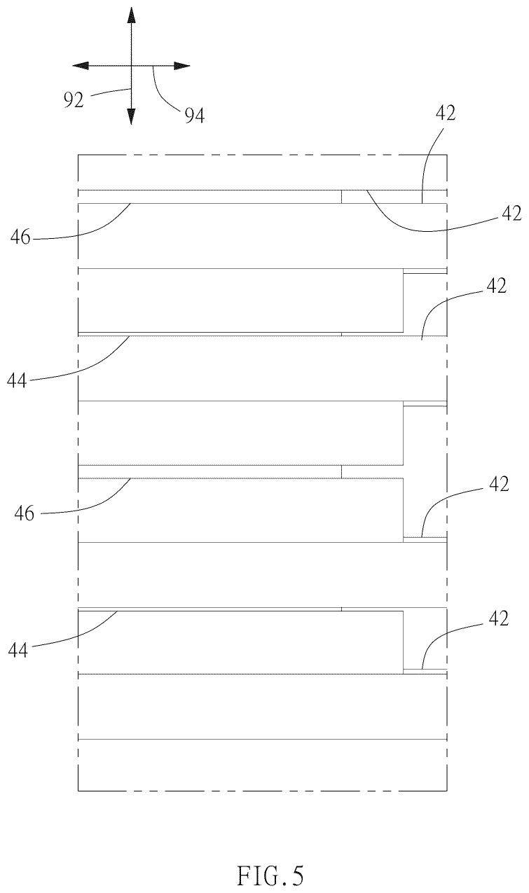

As shown in FIGS. 3, 4, and 5, the battery cell module 40 comprises multiple battery cells 42. Each battery cell 42 is used to store electrical energy and has a length and a thickness. Each battery cell 42 is equipped with two tabs 43 which act as a positive or a negative pole. The bus structures 20 are positioned at either end of the battery cell module 40, and each tab 43 is electrically connected to one adjacent bus structure 20 so that the battery cells 42 can form series or parallel connections through the tabs 43 and the bus structures 20. The electrodes 30 are used to electrically connect to external power transmission lines (not shown) or electrical equipment (not shown). Each electrode 30 is electrically connected to one bus structure 20, allowing the battery cell module 40 to supply power to the electrical equipment and enabling the external power source to charge the battery cells 42. The above construction is the same as in the prior art.

The battery cell module 40 further comprises multiple first bonding elements 44 and multiple second bonding elements 46. Each first bonding element 44 is a thin film, and each second bonding element 46 is a sheet with a thickness and an elasticity in the thickness direction that allows each second bonding element 46 to elastically compress or expand in the thickness direction. The thickness of the second bonding element 46 is greater than the thickness of the first bonding element 44. Specifically, each first bonding element 44 is made of a double-sided adhesive film, and each second bonding element 46 is made of a foam adhesive composed primarily of foam material.

The thickness direction of the battery cells 42, the first bonding elements 44, and the second bonding elements 46 is defined as a first direction 92. The battery cells 42, the first bonding elements 44, and the second bonding elements 46 are arranged in parallel along the first direction 92. The length direction of the battery cells 42 is defined as a second direction 94, which is perpendicular to the first direction 92. Each battery cell 42 has one tab 43 configured at each end in the second direction 94. The width direction of the battery cells 42 is defined as a third direction 96. The first direction 92 and the second direction 94 are both perpendicular to the third direction 96. The bottom plate 12, the battery cell module 40, and the cover plate 16 are sequentially arranged along the third direction 96.

Each first bonding element 44 is interposed between two battery cells 42 and adheres to its adjacent two battery cells 42. Each second bonding element 46 is also interposed between two battery cells 42 and adheres to its adjacent two battery cells 42. There is only one first bonding element 44 or one second bonding element 46 between two adjacent battery cells 42 along the first direction 92.

Specifically, the first bonding elements 44 and the second bonding elements 46 are preferably arranged alternately along the first direction 92. This alternate arrangement means that each second bonding element 46 is positioned between two first bonding elements 44 along the first direction 92.

Each second bonding element 46 increases the distance between its two adjacent adhered battery cells 42, reducing the heat transfer effect between the adjacent battery cells 42 along the first direction 92. This arrangement facilitates heat transfer along the third direction 96 toward the protective case 10. Compared to the prior art, the preferred embodiment improves the overall heat dissipation efficiency of the battery cell module 40.

By using foam adhesive as the second bonding element 46, the foam material provides enhanced heat insulation which further inhibits heat transfer along the first direction 92 through the second bonding elements 46.

The number of battery cells 42 is directly proportional to the total storage capacity of the battery cell module 40 and is also directly proportional to the heat dissipation requirements of the battery cell module 40. In the preferred embodiment, variations in the number of the battery cells 42 are accommodated by correspondingly adjusting the number of the second bonding elements 46. This ensures that the overall heat dissipation efficiency of the battery cell module 40 remains unaffected, even as the number of battery cells 42 increases.

Each second bonding element 46 can elastically adapt to the expansion or contraction of the adjacent battery cells 42 along the first direction 92, and each second bonding element 46 can absorb and mitigate the relative pressure caused by the expansion of its two bonded battery cells 42.

The arrangement of the multiple first bonding elements 44 balances the dimension of the battery cell module 40 along the first direction 92 with its heat dissipation efficiency. This prevents excessive expansion of the dimension of the battery cell module 40 along the first direction 92 due to the inclusion of the second bonding elements 46.

What is claimed is:

1. A battery cell module of a pouch cell battery, comprising:
multiple battery cells, each battery cell used to store electrical energy and having a length and a thickness, each battery cell equipped with two tabs, and each tab acting as a positive or a negative pole of the battery cell;
multiple first bonding elements, each first bonding element being a thin film; and
multiple second bonding elements, each second bonding element being a sheet with a thickness and an elasticity in the thickness direction, allowing each second bonding element to elastically compress or expand in the thickness direction, the thickness of each second bonding element being greater than the thickness of each first bonding element;
wherein the thickness direction of the battery cells, the first bonding elements, and the second bonding elements is defined as a first direction, the battery cells, the first bonding elements, and the second bonding elements are arranged parallel along the first direction, the length direction of the battery cells is defined as a second direction, which is perpendicular to the first direction, and each battery cell has one tab configured at each end in the second direction;
each first bonding element is interposed between two battery cells and adheres to the adjacent two battery cells, each second bonding element is also interposed between two battery cells and adheres to the adjacent two battery cells, and between the two adjacent battery cells along the first direction, there is only one first bonding element or one second bonding element.

2. The battery cell module of a pouch cell battery according to claim 1, wherein the first bonding elements and second bonding elements are arranged alternately along the first direction.

3. The battery cell module of a pouch cell battery according to claim 1, wherein each first bonding element is a double-sided adhesive film.

4. The battery cell module of a pouch cell battery according to claim 1, wherein each second bonding element is primarily composed of foam material.
